(19) United States
(12) Patent Application Publication
(10) Pub. No.: US 2024/0094548 A1
(43) Pub. Date: Mar. 21, 2024

(54) Electronic Devices With Movable Optical Assemblies

(71) Applicant: Apple Inc., Cupertino, CA (US)

(72) Inventors: Shannon Pomeroy, San Francisco, CA (US); Kristina A. Babiarz, San Jose, CA (US); Jia Tao, San Jose, CA (US); Aidan N. Zimmerman, Poway, CA (US); Matin Seadat Beheshti, Sunnyvale, CA (US); Blake N. Trekell, San Francisco, CA (US); William W. Sprague, San Francisco, CA (US); Anna V. Mirabella, San Francisco, CA (US)

(21) Appl. No.: 18/351,296

(22) Filed: Jul. 12, 2023

Related U.S. Application Data
(60) Provisional application No. 63/406,902, filed on Sep. 15, 2022.

(51) Int. Cl. G02B 27/01; G02B 7/12

(52) U.S. Cl. CPC G02B 27/0176; G02B 7/12; G02B 2027/0154

(57) ABSTRACT

A head-mounted device may include optical assemblies for presenting images to a user. Motors may be used to adjust the spacing between the optical assemblies to accommodate different interpupillary distances. Gaze trackers may be used to make interpupillary distance measurements and eye relief measurements. Adjustments to the positions of the optical assemblies may be made by the motors based on the interpupillary distance measurements and eye relief measurements.

This application claims the benefit of provisional patent application No. 63/406,902, filed Sep. 15, 2022, which is hereby incorporated by reference herein in its entirety.

### FIELD

This relates generally to electronic devices, and, more particularly, to electronic devices such as head-mounted devices.

### BACKGROUND

Electronic devices have components such as displays. The positions of these components may sometimes be adjusted.

### SUMMARY

A head-mounted device may include optical assemblies with displays for presenting images to a user. Motors may be used to adjust the spacing between the optical assemblies and thereby adjust the spacing between the displays to accommodate different interpupillary distances.

The optical assemblies may have gaze trackers. The gaze trackers may be used to make interpupillary distance measurements and eye relief measurements. Adjustments to the positions of the optical assemblies may be made by the motors based on the interpupillary distance measurements and eye relief measurements. For example, no position adjustments may be made unless a measured eye relief measurement exceeds an eye relief threshold and the measured interpupillary distance is lower than an interpupillary distance threshold. If the measured eye relief measurement is sufficiently large and the measured interpupillary distance is sufficiently small, adjustments to the positions of the optical assemblies may be made in which, for a given measured eye relief, a smaller measured interpupillary distance results in a larger adjustment to an optical assembly position than a larger measured interpupillary distance.

### BRIEF DESCRIPTION OF THE DRAWINGS

FIG. 1 is a diagram of an illustrative head-mounted device in accordance with an embodiment.

FIGS. 2 and 3 are rear views of portions of illustrative head-mounted devices in accordance with embodiments.

FIG. 4 is a graph in which illustrative optical assembly adjustment values are plotted as a function of measured eye relief for multiple different illustrative measured interpupillary distances in accordance with an embodiment.

FIG. 5 is a flow chart of illustrative operations involved in using a head-mounted device in accordance with an embodiment.

### DETAILED DESCRIPTION

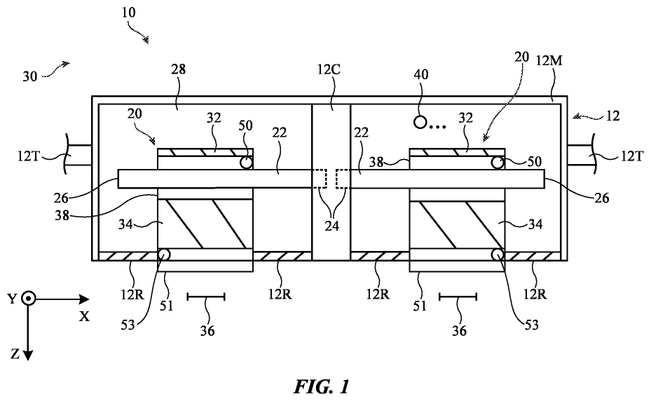

FIG. 1 is a schematic diagram of an illustrative electronic device of the type that may include movable components. Device 10 of FIG. 1 may be a head-mounted device (e.g., goggles, glasses, a helmet, and/or other head-mounted device), a cellular telephone, a tablet computer, a laptop computer, a wristwatch, a peripheral device (sometimes referred to as a peripheral) such as a pair of headphones, or other electronic equipment. In an illustrative configuration, device 10 is a head-mounted device such as a pair of goggles (sometimes referred to as virtual reality goggles, mixed reality goggles, augmented reality glasses, etc.).

As shown in the illustrative top view of device 10 of FIG. 1, device 10 may have a housing such as housing 12 (sometimes referred to as a head-mounted support structure or head-mounted support). Housing 12 may include a main portion such as portion 12M (sometimes referred to as a main unit or head-mounted unit) and other head-mounted support structures such as head strap 12T. When housing 12 is being worn on the head of a user, the front of housing 12 may face outwardly away from the user, the rear of housing 12 may face towards the user, and the user's eyes may be located in eye boxes 36.

Device 10 may have electrical and optical components that are used in displaying images to eye boxes 36 when device 10 is being worn. These components may include left and right optical assemblies 20 (sometimes referred to as optical modules). Each optical assembly 20 may have an optical assembly support 38 (sometimes referred to as a lens barrel or optical module support) and guide rails 22 along which optical assemblies 20 may slide to adjust optical-assembly-to-optical-assembly separation to accommodate different user interpupillary distances.

Each assembly 20 may have a display 32 that has an array of pixels for displaying images and a lens 34. Display 32 and lens 34 of each assembly 20 may be coupled to and supported by support 38. During operation, images displayed by displays 32 may be presented to eye boxes 36 through lenses 34 for viewing by a user. Each optical assembly 20 may also have a gaze tracker 50. Gaze trackers 50 may each include one or more light sources (e.g., infrared light-emitting diodes that provide flood illumination and glints for eye tracking) and an associated camera (e.g., an infrared camera). Using gaze trackers 50, which may sometimes be referred to as gaze tracking systems or gaze tracking sensors, device 10 can gather data on a user's eyes located in eye boxes 36. As an example, the direction in which a user's eyes are pointing (sometimes referred to as a user's point of gaze or direction of view) may be measured. Biometric information such as iris scan information may also be gathered. In addition, gaze trackers 50, may be used to measure the location of a user's eyes relative to device 10 and thereby measure the eye relief of the user's eyes (e.g., the distance between the lenses of device 10 and the eyes) and the separation between the user's left and right eyes (sometimes referred to as the user's interpupillary distance). If desired, gaze trackers 50 (e.g., the cameras of trackers 50) may capture images of the skin of the user's face surrounding the user's eyes (e.g., to measure whether this skin is loose or taut).

Each optical assembly may have magnets, clips, and/or other engagement features to allow removable vision correction lenses (sometimes referred to as prescription lenses) to be removably attached to assemblies 20 in alignment with lenses 34 (see, e.g., illustrative optional vision correction lenses 51). Lenses 51 may have magnets that are sensed by sensors 53 (e.g., magnetic sensors in assemblies 20) or sensors 53 may be optical sensors, switches, or other sensors configured to gather other information indicating when lenses 51 are present.

Housing 12 may have a flexible curtain (sometimes referred to as a flexible rear housing wall or fabric housing wall) such as curtain 12R on the rear of device 10 facing eye boxes 36. Curtain 12R has openings that receive assemblies 20. The edges of curtain 12R that surround each support 38 may be coupled to that support 38. The outer peripheral edge of curtain 12R may be attached to rigid housing walls forming an outer shell portion of main housing 12M.

The walls of housing 12 may separate interior region 28 within device 10 from exterior region 30 surrounding device 10.

Inner ends 24 of guide rails 22 may be attached to central housing portion 12C. Opposing outer ends 26 may, in an illustrative configuration, be unsupported (e.g., the outer end portions of rails 22 may not directly contact housing 12, so that these ends float in interior region 28 with respect to housing 12).

Device 10 may include control circuitry and other components such as component 40. The control circuitry may include storage, processing circuitry formed from one or more microprocessors and/or other circuits. To support communications between device 10 and external equipment, the control circuitry may include wireless communications circuitry. Components 40 may include sensors such as such as force sensors (e.g., strain gauges, capacitive force sensors, resistive force sensors, etc.), audio sensors such as microphones, touch and/or proximity sensors such as capacitive sensors, optical sensors such as optical sensors that emit and detect light, ultrasonic sensors, and/or other touch sensors and/or proximity sensors, monochromatic and color ambient light sensors, image sensors, sensors for detecting position, orientation, and/or motion (e.g., accelerometers, magnetic sensors such as compass sensors, gyroscopes, and/or sensors such as inertial measurement units that contain some or all of these sensors), radio-frequency sensors, depth sensors (e.g., structured light sensors and/or depth sensors based on stereo imaging devices), optical sensors such as self-mixing sensors and light detection and ranging (lidar) sensors that gather time-of-flight measurements, humidity sensors, moisture sensors, visual inertial odometry sensors, gaze tracking sensors, and/or other sensors. In some arrangements, devices 10 may use sensors to gather user input (e.g., button press input, touch input, etc.). Sensors may also be used in gathering environmental motion (e.g., device motion measurements, temperature measurements, ambient light readings, etc.) and/or may be used in measuring user activities and/or attributes (e.g., point-of-gaze, eye relief, interpupillary distance, etc.). If desired, position sensors such as encoders (e.g., optical encoders, magnetic encoders, etc.) may measure the position and therefore the movement (e.g., the velocity, acceleration, etc.) of optical assemblies 20 along rails 22.

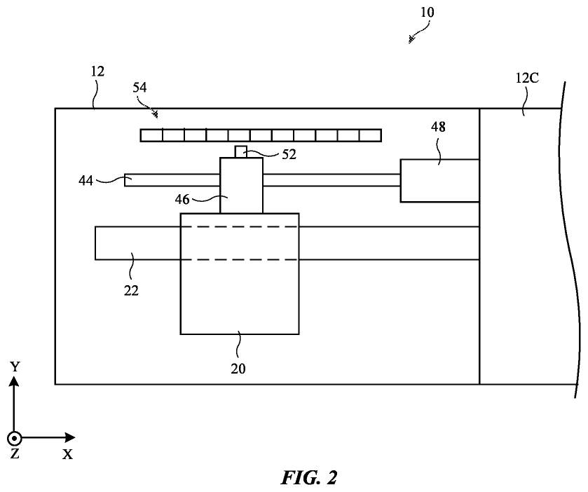

FIG. 2 is a rear view of an illustrative portion of device 10 (e.g., an inside left portion). Device 10 may have left and right actuators (e.g., motors) such as motor 48 that are used to rotate an elongated threaded shaft such as screw 44. Nut 46 has threads that engage the threads on screw 44. As the motor 48 on each side of device 10 is turned, a corresponding nut 46 is driven in the +X or −X direction (in accordance with whether screw 44 is being rotated clockwise or counterclockwise). In turn, this moves the optical assembly 20 on that side of device 10 in the +X or −X direction along its optical assembly guide rail 22. If desired, the left and right motors 48 may be adjusted independently, so that optical assemblies 20 on the left and right of device 10 may be moved independently.

Each assembly 20 (e.g., each support 38 of FIG. 1) may have portions that receive a corresponding rail 22 and that guide that assembly 20 along that rail 22. By controlling the activity of motors 48 in tandem or individually, the spacing between the left and right optical assemblies of device 10 can be adjusted to accommodate the interpupillary distance of different users. For example, if gaze trackers 50 determine that a user has closely spaced eyes, assemblies 20 may be moved inwardly (towards each other) and if a user has widely spaced eyes, assemblies 20 may be moved outwardly (away from each other). By matching the spacing between optical assemblies 20 to the measured interpupillary distance of a user, the user may satisfactorily view visual content being presented by the displays of the optical assemblies.

The position and therefore the movement of each optical assembly may be monitored using one or more sensors. In the illustrative configuration of FIG. 2, motor 48 (e.g., the motor on the left side of device 10) and optical module 20 have been provided with an optical assembly position sensor based on a magnetic encoder. The encoder includes magnetic strip 54 and magnetic sensor 52. Magnetic sensor 52 may be a Hall Effect sensor or other suitable magnetic sensor that is configured to move with optical assembly 20. Magnetic strip 54, which may be affixed to housing 12, has a series of magnet poles (e.g., north and south poles) that extend along the X dimension parallel to guide rail 22 and parallel to the X-axis position adjustment direction associated with optical assembly 20. As optical assembly 20 is moved along guide rail 22, the magnetic encoder (e.g., sensor 52) measures the change in magnetic field resulting as magnetic sensor 52 passes by different magnets in strip 54. In this way, optical assembly 20 is provided with a position reference (e.g., by counting north and south magnetic poles in strip 54). The position measurements made with the position sensor may reveal attributes of the motion of optical assembly 20 such as the velocity of optical assembly 20 and, if desired, the acceleration and deceleration of assembly 20. Accordingly, the magnetic encoder (or other position sensor) associated with each optical assembly 30 may be used by device 10 to measure the location of that optical assembly so that the spacing between optical assemblies 20 can be satisfactorily adjusted (e.g., to help ensure that the spacing between optical assemblies 20 has been adjusted to match or nearly match the user's interpupillary distance). The position readings from the optical assembly position sensors (e.g., the magnetic encoders) may also be used to determine the velocities of the optical assemblies as they are moved.

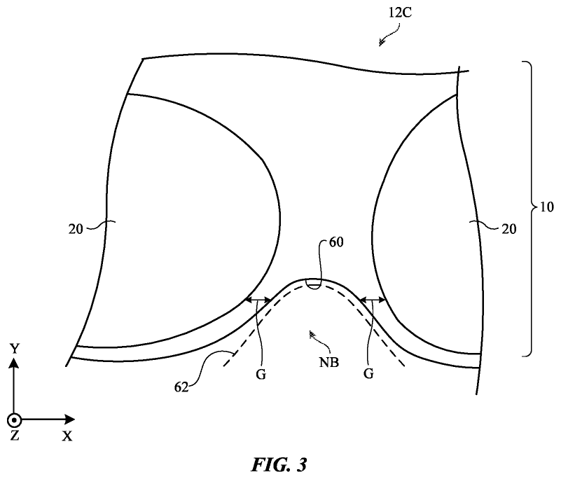

Optical assembly velocity information and/or other information from the optical assembly position sensors (e.g., linear position sensors formed from the magnetic encoders) may be used in monitoring whether the optical assemblies have slowed down their movement due to contact between the optical assemblies and the nose of a user. Consider, as an example, the arrangement of FIG. 3. FIG. 3 is a rear view of a central nose-bridge portion NB of device 10. As shown in FIG. 3, nose bridge portion NB of housing portion 12C has a nose-shaped recess 60, which is configured to receive the user's nose (see, e.g., illustrative nose surface 62). In some situations (e.g., when a user has a wide interpupillary distance), optical assemblies 20 reside at a non-zero distance G from surface 62 (sometimes referred to as gap G) after motors 48 adjusted the positions of assemblies 20 to match the user's interpupillary distance. In other situations, such as when a user has a large eye relief and small interpupillary distance, motors 48 may move optical assemblies inward until curtain 12R (FIG. 1) and optical assemblies 20 contact the left and right sides of nose surface 62.

When optical assemblies 20 contact the left and right sides of nose surface of 62, motors 48 will encounter resistance to further lateral movement of the optical assemblies along the X axis. This will cause optical assemblies 20 to move more slowly. The optical assembly position sensors will sense the reduction in the velocity of the optical assemblies. In this way, device 10 is informed that optical assemblies 20 are contacting and pressing against nose surface 62. To ensure that device 10 is comfortable as device 10 is being worn on the head of the user, the position of the optical assemblies may, in response to this detected nose contact, be adjusted outward, away from nose surface 62 (e.g., by 1-3 mm or other suitable amount). This outward nudge in the positions of the optical assemblies may be made even if the final separation between the optical assemblies is slightly larger than the user's measured interpupillary distance.

Following outward adjustment of optical assemblies 20, a non-zero gap G may be created between optical assemblies 20 and corresponding side portions of the user's nose (e.g., adjacent portions of nose surface 62) and/or inward pressure imposed on the sides of the user's nose by optical assemblies 20 can be reduced to enhance comfort. By monitoring the optical assembly position sensors during optical assembly position adjustment with motors 48, device 10 can identify a location for assemblies 20 in which the left and right assemblies 20 are separated by distance that is matched as closely as possible to the user's measured interpupillary distance while ensuring satisfactory comfort for the user.

Another way in which the position of optical assemblies 20 can be adjusted satisfactorily involves the use of eye relief measurements from gaze trackers 50. When device 10 is placed onto the head of the user, gaze trackers 50 may measure the user's interpupillary distance and may measure the user's eye relief. Motors 48 may then adjust the positions of optical assemblies 20 based on the measured eye relief and measured interpupillary distance of the user. In an illustrative configuration, the positions of optical assemblies 20 maybe offset (e.g., nudged outwards from the location where the spacing between assemblies 20 matches the measured interpupillary distance of the user) by an amount that varies depending on both measured interpupillary distance and measured eye relief.

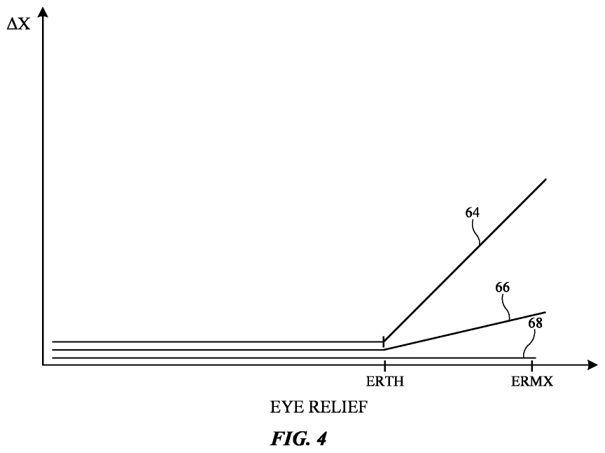

This type of approach is illustrated in the graph of FIG. 4. In the graph of FIG. 4, lateral offset ΔX represents the distance by which an optical assembly is adjusted outwardly (beyond the nominal position in which optical assembly separation matches measured interpupillary distance) to enhance fit. There are three illustrative curves in the graph of FIG. 4. Curve 64 corresponds to a measured interpupillary distance IPDA, curve 66 corresponds to a measured interpupillary distance IPDB, which is larger than interpupillary distance IPDA, and curve 68 corresponds to a measured interpupillary distance IPDC, which is larger than interpupillary distance IPDA and larger than interpupillary distance IPDB. The values of IPDA, IPDB, and IPDC may be in the range of 52 to 74 mm or any other suitable range. In practice, device 10 may store a family of curves (e.g., empirically determined curves) for any suitable number of measured interpupillary distances and/or may represent the relationships embodied in curves such as curves 64, 66, and 68 using tables, functions, and/or other data structures.

As the graph of a FIG. 4 illustrates, if the measured eye relief a user falls below a predetermined threshold (e.g., ERTH in the example of FIG. 4), the user is unlikely to experience pressure from optical assemblies 20 on the sides of the user's nose. Accordingly, for measured user eye relief values below eye relief threshold ERTH, optical assemblies 20 may be separated along the X axis by a distance that matches the measured interpupillary distance of the user (e.g., there is no need to use a non-zero value of ΔX to adjust the position of optical assemblies 20 outwardly after they have reached the appropriate spacing to match the user's interpupillary distance). The value of ΔX is therefore zero for users with measured eye relief values of less than ERTH (which may be, for example, a value between 18 mm and 22 mm or other suitable eye relief threshold value).

If, however, the measured eye relief of a user exceeds eye relief threshold ERTH, it may be beneficial for certain users to increase the spacing between optical assemblies 20 by nudging each optical assembly outwardly by an amount ΔX. As an example, consider users with measured interpupillary distances of IPDA. For this class of user, it may be beneficial to adjust the spacing of optical assemblies 20 outwardly by ΔX values that follow curve 64. As shown by curve 64, ΔX may be zero for measured eye relief values of less than ERTH, whereas for measured eye relief values exceeding ERTH, ΔX may rise progressively as a function of measured eye relief (e.g., up to a maximum ΔX value at a maximum measured eye relief value of ERMX, which may be, for example, 25 mm or other suitable value). Users with larger interpupillary distances, such as a measured interpupillary distance of IPDB, may benefit from a less aggressive outward increase in optical assembly spacing, as shown by curve 66 in which the value of ΔX rises more slowly as a function of increasing measured eye relief over ERTH than curve 64.

An interpupillary distance threshold may be present above which it may not be desirable to make any ΔX adjustments for a user, regardless of their measured eye relief. When, for example, a user has a large measured interpupillary distance (e.g., a measured interpupillary distance of IPDC, which exceeds the interpupillary distance threshold), there will generally not be a comfort benefit in increasing optical assembly spacing. As a result, the recommended outward adjustment in optical assembly position ΔX as a function of measured eye relief for users with these larger measured interpupillary distances follows curve 68 (e.g., ΔX remains at zero, even for a measured eye relief of ERMX). With this approach, only at measured interpupillary distances below the interpupillary distance threshold will outward adjustments in optical assembly position be used.

The graph of FIG. 4 illustrates how motors 48 may place optical assemblies 20 at positions that vary from the measured positions of the user's eyes. In the example of FIG. 4, measured eye relief and interpupillary distance values were used in determining satisfactory positions for assemblies 20. In particular, outward adjustments ΔX in the positions of optical assemblies 20 were recommended as a function of the interpupillary distance and eye relief values measured for a user with gaze trackers 50. If desired, additional factors may be taken into consideration in making optical assembly adjustments such as these (e.g., additional factors that may be used in combination with or as an alternative to using interpupillary distance measurements and eye relief measurements) and/or other suitable action may be taken based on data gathered with gaze trackers 50 and/or other sensors in device 10.

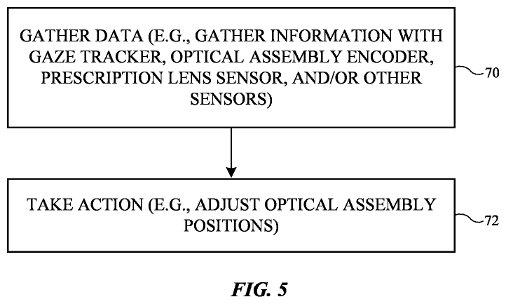

FIG. 5 is a flow chart illustrating operations involved in using motors 48 and other components in device 10 to make adjustments to device 10 as a function of data gathered with gaze trackers 50 and/or other sensors.

During the operations of block 70, device 10 may gather data. The gathered data may include, for example, measurements obtained by gaze trackers 50. These measurements may include, for example, the measured interpupillary distance of a user wearing device 10, the measured eye relief of a user wearing device 10, the measured skin tautness around the eyes of a user wearing device 10, and/or other gaze tracker measurements. The measurements of block 70 may also include measurements with the position sensors (e.g., the magnetic encoders) of optical assemblies 20. For example, when a user dons device 10, motors 48 may automatically start to move optical assemblies 20 to positions associated with the user's measured interpupillary distance from gaze trackers 50. During this initial movement or during movement in response to a user input command or other movement, the position sensors may be used to monitor the velocities of assemblies 20. In response to detected slowing of the speed of inward movement of assemblies 20, device 10 can conclude that assemblies 20 are beginning to exert pressure on the sides of the user's nose (e.g., nose surface 62). The locations associated with the measured reduction in optical assembly velocity are another form of measurement data that may be gathered during block 70.

Further information that can be gathered during the operations of block 70 relates to the status of vision correction lenses 51 on device 10. Vision correction lenses 51 may contain magnets that produce a magnetic field. Device 10 (e.g., assemblies 20) may have vision correction lens sensors such as magnetic sensors 53 that determine whether or not lenses 51 are present by monitoring for the presence of the magnetic fields produced by lenses 51. In response to detection of the magnetic fields from lenses 51 with sensors 53, it can be concluded that lenses 51 are present.

During the operations of block 72, device 10 can take action based on the data gathered at block 70. As an example, the positions of optical assemblies 20 may be adjusted using motors 48. In some configurations, the positions of optical assemblies 20 may be nudged outwards by an amount ΔX determined from measured interpupillary distance and eye relief values, as described in connection with FIG. 4. If desired, optical assemblies 20 may, in some scenarios, be moved inward slightly (e.g., assemblies 20 may be moved towards each other such that assemblies 20 are closer than dictated by the measured value of a user's interpupillary distance to increase nasal field-of-view overlap when doing so presents a low risk of optical assembly nose surface contact or when any potential nose contact can be detected with an optical module position sensor or other sensor). To reduce wrinkles in rear curtain 12R, optical assemblies 20 may be moved inwards or outwards slightly to tighten curtain 12R. Optical assembly movement with motors 48 may also be used to provide a user with an alert (e.g., a haptic alert indicating that an incoming message has been received and/or another condition has been determined to be present). In some arrangements, gaze sensor measurements from trackers 50 during block 70 can be used to determine whether the user's skin surrounding the user's eyes is taut. In response to detecting an increase in skin tautness as assemblies 20 are moved (e.g., as assemblies 20 are being moved towards each other), it can be concluded that assemblies 20 are pressing or are about to press on nose surface 62, so further movement inward of assemblies 20 can be halted and/or assemblies 20 may be nudged outwardly to compensate. The positions of optical assemblies 20 may also be adjusted in response to detection that vision correction lenses 51 are present or are not present. The presence of lenses 51 may, as an example, increase or decrease the risk of nose contact by assemblies 20, so information on the presence of lenses 51 (and, if desired, the prescription associated with lenses 51) may be taken into account when using motors 48 to adjust the position of assemblies 20. In general, these types of adjustments and/or other suitable actions may be taken during the operations of block 72 in response to gaze tracker measurement data and/or other data measured during the operations of block 70.

To help protect the privacy of users, any personal user information that is gathered by sensors may be handled using best practices. These best practices including meeting or exceeding any privacy regulations that are applicable. Opt-in and opt-out options and/or other options may be provided that allow users to control usage of their personal data.

The foregoing is merely illustrative and various modifications can be made to the described embodiments. The foregoing embodiments may be implemented individually or in any combination.

What is claimed is:

1. A head-mounted device, comprising:
a head-mounted housing;
an optical assembly in the head-mounted housing that is configured to provide an image to an eye box;
a gaze tracker; and
a motor configured to position the optical assembly based on a measured eye relief from the gaze tracker and a measured interpupillary distance from the gaze tracker.

2. The head-mounted device defined in claim 1 wherein the motor is configured to move the optical assembly outward from a central portion of the head-mounted housing in response to determining that the measured eye relief is more than a predetermined threshold amount.

3. The head-mounted device defined in claim 1 wherein the motor is configured to adjust the position of the optical assembly outwards by a first amount in response to determining that the measured eye relief has an eye relief value that is more than a predetermined threshold amount and that the measured interpupillary distance has a first value and is configured to move the optical assembly outwards by a second amount that is more than the first amount in response to determining that the measured eye relief has the eye relief value and that the measured interpupillary distance has a second value that is less than the first value.

4. The head-mounted device defined in claim 1 further comprising a vision correction lens sensor, wherein the motor is further configured to position the optical assembly based on information from the vision correction lens sensor.

5. The head-mounted device defined in claim 1 wherein the optical assembly is configured to receive a removable vision correction lens with a magnet that produces a magnetic field and wherein the motor is further configured to position the optical assembly based on information from the magnetic sensor.

6. The head-mounted device defined in claim 1 wherein the motor is configured to provide a haptic alert by moving the optical assembly.

7. The head-mounted device defined in claim 1 wherein the gaze tracker is configured to measure skin tautness.

8. The head-mounted device defined in claim 7 wherein the motor is further configured to adjust the position of the optical assembly based on the measured skin tautness.

9. A head-mounted device, comprising:
a head-mounted housing;
left and right optical assemblies in the head-mounted housing that are separated by a separation distance and that are configured to provide respective left and right images to left and right eye boxes;
a left gaze tracker in the left optical assembly;
a right gaze tracker in the right optical assembly, wherein the left and right gaze trackers are configured to measure an interpupillary distance and an eye relief; and
left and right motors configured to respectively position the left and right optical assemblies, wherein the left and right motors are configured to adjust the separation distance to be different than the measured interpupillary distance based on the measured eye relief.

10. The head-mounted device defined in claim 9 wherein the left and right motors are configured to adjust the separation distance to be greater than the measured interpupillary distance based on the measured eye relief exceeding a predetermined eye relief threshold.

11. The head-mounted device defined in claim 10 wherein the left and right motors are configured to adjust the separation distance to be greater than the measured interpupillary distance based on the measured interpupillary distance.

12. The head-mounted device defined in claim 11 wherein the left and right motors are configured to adjust the separation distance to be greater than the measured interpupillary distance based on the measured interpupillary distance being below a predetermined interpupillary distance threshold.

13. The head-mounted device defined in claim 9 further comprising a vision correction lens presence sensor, wherein the left and right motors are configured to adjust the separation distance based on information from the vision correction lens presence sensor.

14. The head-mounted device defined in claim 13 wherein the left and right optical assemblies are configured to receive left and right vision correction lenses, respectively, and wherein the vision correction lens presence sensor comprises a magnetic sensor configured to measure a magnetic field from the left or right vision correction lens.

15. The head-mounted device defined in claim 9 wherein the left and right gaze trackers are configured to measure skin tautness.

16. The head-mounted device defined in claim 15 wherein the left and right motors are configured to adjust the separation distance to be greater than the measured interpupillary distance based on the measured skin tautness.

17. A head-mounted device, comprising:
an optical assembly having a lens, a display configured to display an image to an eye box through the lens, and a gaze tracker configured to make an interpupillary distance measurement and an eye relief measurement through the lens; and
a motor configured to adjust a position of the optical assembly based on the eye relief measurement.

18. The head-mounted device defined in claim 17 further comprising a head-mounted housing and a guide rail in the head-mounted housing along which the optical assembly slides, wherein the motor is configured to adjust the position of the optical assembly by moving the optical assembly along the rail based on the eye relief measurement.

19. The head-mounted device defined in claim 18 wherein the motor is configured to adjust the position of the optical assembly based on the interpupillary distance measurement.

20. The head-mounted device defined in claim 19 wherein the motor is configured to adjust the position of the optical assembly outwardly away from a center portion of the head-mounted housing based on the interpupillary distance measurement and the eye relief measurement.
